(19) United States
(12) Patent Application Publication
(10) Pub. No.: US 2014/0148987 A1
(43) Pub. Date: May 29, 2014

(54) CONTROL DEVICE FOR HYBRID VEHICLE

(71) Applicants: Hideaki Otsubo, Miyoshi-shi (JP); Naoki Ishikawa, Toyota-shi (JP); Hideharu Nohara, Toyota-shi (JP)

(72) Inventors: Hideaki Otsubo, Miyoshi-shi (JP); Naoki Ishikawa, Toyota-shi (JP); Hideharu Nohara, Toyota-shi (JP)

(73) Assignee: TOYOTA JIDOSHA KABUSHIKI KAISHA, Toyota-shi (JP)

(21) Appl. No.: 14/117,914

(22) PCT Filed: May 16, 2011
(86) PCT No.: PCT/JP2011/061178

§ 371 Date: Nov. 15, 2013

(51) Int. Cl. B60W 20/00; B60K 6/445; B60K 26/02

(52) U.S. Cl. CPC B60W 20/30; B60K 26/02; B60K 6/445; Y10S 903/902
USPC 701/22; 180/65.235

(57) ABSTRACT

A control device of a hybrid vehicle has an electric shift mechanism including a differential mechanism having a first rotating element coupled to an engine in a power transmittable manner, a second rotating element coupled to a differential electric motor in a power transmittable manner, and a third rotating element that is an output rotating member coupled to an electric motor for running in a power transmittable manner, and a mechanical shift mechanism, and makes a differential torque smaller between an output torque of the engine and an engagement torque of the engagement devices involved in a shift of the mechanical shift mechanism on the same shaft in a case of a shift with a smaller rotation speed change in the engine as compared to a case of a shift with a larger rotation speed change in the engine in the same type of shift in the mechanical shift mechanism.

### TECHNICAL FIELD

The present invention relates to a control device of a hybrid vehicle including an electric shift mechanism having a differential mechanism and a mechanical shift mechanism in series and particularly to a technique when shift control of the mechanical shift mechanism is provided.

### BACKGROUND ART

A stepped automatic transmission for a vehicle is well known that engages/releases friction engagement devices to form a predetermined shift stage. For example, this corresponds to an automatic transmission described in Patent Document 1. In general, in such a stepped automatic transmission, for example, in response to determination of a rotation condition for performing a shift (e.g., any of vehicle speed, shift input rotation speed, engine rotation speed etc.) and a torque condition (e.g., any of transmission input torque, engine torque, or a value controlling the engine torque such as throttle valve opening degree, accelerator opening degree or an intake air amount, etc.), an inertia change amount is uniquely determined that is generated by a change in the transmission input rotation speed and a change in the engine rotation speed associated with the same type of shift in the stepped automatic transmission (i.e., a shift of the same shift type (e.g., upshift from one to two) in the stepped automatic transmission), i.e., a rotational change in an engine and a rotational change in a rotating member making up the stepped automatic transmission at the time of shift of the same type. Therefore, as described in Patent Document 1, the stepped automatic transmission has a clutch pressure of engagement devices to be responsible for the engine torque at the time of shift and a change in inertia associated with the shift (or a line pressure of a hydraulic circuit acting as an original pressure of the clutch pressure) set based on the engine torque and is controlled to avoid an excess or a shortage of the clutch pressure relative to the transmission input torque.

### PRIOR ART DOCUMENT

### Patent Document

### Patent Document 1: Japanese Laid-Open Patent Publication No. 6-280988

### SUMMARY OF THE INVENTION

### Problem to Be Solved by the Invention

A hybrid vehicle is also well known that includes an electric shift mechanism including a differential mechanism having three rotating elements, which are a first rotating element coupled to an engine in a power transmittable manner, a second rotating element coupled to a differential electric motor in a power transmittable manner, and a third rotating element that is an output rotating member coupled to an electric motor for running in a power transmittable manner, the electric shift mechanism having a differential state of the differential mechanism controlled by controlling an operational state of the differential electric motor, and a mechanical shift mechanism (i.e., a stepped automatic transmission) making up a portion of a power transmission path between the output rotating member of the electric shift mechanism and drive wheels and having a shift stage formed by engagement of engagement devices. Such a hybrid vehicle can arbitrarily (freely) control an engine rotation speed and a rotation speed of the differential electric motor without being constrained by a state of an input rotating member of the mechanical shift mechanism (hereinafter referred to as an AT input shaft), for example. Therefore, the engine rotation speed can freely be changed regardless of a change in AT input shaft rotation speed associated with a shift of the mechanical shift mechanism. For example, in the same type of shift in the mechanical shift mechanism, the hybrid vehicle can perform an equal power shift, in which the mechanical shift mechanism is shifted without changing engine power while an engine operating point (e.g., an operational point of the engine determined by an engine rotation speed and an engine torque) is fixed before and after the shift, or can perform a non-equal power shift, in which the mechanical shift mechanism is shifted while the engine power is changed by moving the engine operating point before and after the shift.

Therefore, an inertia change amount of the whole power transmission device (the electric shift mechanism+the mechanical shift mechanism) generated during a shift of the mechanical shift mechanism cannot uniquely be determined and, even if a clutch pressure of the engagement devices in transition during the shift is set based on an engine torque, an excess or a shortage of the clutch pressure may occur relative to the torque to be received by the engagement devices. As a result, the shift of the mechanical shift mechanism may not properly progress and may generate a shift shock. Such a problem is not known and no proposal has been made for setting a clutch pressure of the engagement device with attention focused on a difference in a change in inertia of the whole power transmission device (the electric shift mechanism+the mechanical shift mechanism) in the same type of shift in the mechanical shift mechanism.

The present invention was conceived in view of the situations and it is therefore an object of the present invention to provide a control device of a hybrid vehicle that can implement a proper shift with a shift shock suppressed in the same type of shift in the mechanical shift mechanism.

### Means for Solving the Problem

To achieve the object, the first aspect of the invention provides (a) a control device of a hybrid vehicle having an electric shift mechanism including a differential mechanism having three rotating elements, which are a first rotating element coupled to an engine in a power transmittable manner, a second rotating element coupled to a differential electric motor in a power transmittable manner, and a third rotating element that is an output rotating member coupled to an electric motor for running in a power transmittable manner, the electric shift mechanism having a differential state of the differential mechanism controlled by controlling an operational state of the differential electric motor, and a mechanical shift mechanism making up a portion of a power transmission path between the output rotating member of the electric shift mechanism and drive wheels, the mechanical shift mechanism having a shift stage formed by engagement of engagement devices, (b) the control device making a differential torque smaller between an output torque of the engine and an engagement torque of the engagement devices involved in a shift of the mechanical shift mechanism on the same shaft in a case of a shift with a smaller rotation speed change in the engine as compared to a case of a shift with a larger rotation speed change in the engine in the same type of shift in the mechanical shift mechanism.

### Effects of the Invention

Consequently, since the differential torque between the output torque of the engine and the engagement torque of the engagement devices involved in a shift of the mechanical shift mechanism on the same shaft is made smaller in a case of a shift with a smaller rotation speed change in the engine as compared to a case of a shift with a larger rotation speed change in the engine in the same type of shift in the mechanical shift mechanism, the engagement torque of the engagement devices involved in a shift of the mechanical shift mechanism can be set based on an inertia change amount of the engine having the largest inertia in the whole power transmission system including the engine. Therefore, a proper engagement torque can be set in consideration of the torque transmission corresponding to the output torque of the engine and the differential torque corresponding to a change in inertia. As a result, a proper shift can be implemented with a shift shock suppressed in the same type of shift in the mechanical shift mechanism.

The second aspect of the invention provides the control device of a hybrid vehicle recited in the first aspect of the invention, wherein the differential torque is a value set in advance for each of the case of the shift with a smaller rotation speed change in the engine and the case of the shift with a larger rotation speed change in the engine. Consequently, the engagement torque of the engagement devices involved in a shift of the mechanical shift mechanism can properly be set based on the differential torque.

The third aspect of the invention provides the control device of a hybrid vehicle recited in the first or second aspect of the invention, wherein the shift with a smaller rotation speed change in the engine is an equal power shift, in which the mechanical shift mechanism is shifted without changing an output power of the engine before and after the shift, and wherein the shift with a larger rotation speed change in the engine is a non-equal power shift, in which the mechanical shift mechanism is shifted while an output power of the engine is changed before and after the shift. Consequently, a proper engagement torque can be set at the time of each of the equal power shift and the non-equal power shift in the same type of shift in the mechanical shift mechanism.

The fourth aspect of the invention provides the control device of a hybrid vehicle recited in the third aspect of the invention, wherein in the case of the non-equal power shift, when a change amount of the output power of the engine before and after the shift is larger, the differential torque is made larger. Consequently, a more proper shift can be implemented in the same type of shift in the mechanical shift mechanism.

The fifth aspect of the invention provides the control device of a hybrid vehicle recited in the third or fourth aspect of the invention, wherein the equal power shift and the non-equal power shift are selected through a user operation. Consequently, a proper engagement torque can be set in the same type of shift in the mechanical shift mechanism when either the equal power shift or the non-equal power shift is selected through an operation by the user.

### BRIEF DESCRIPTION OF THE DRAWINGS

FIG. 1 is a diagram for explaining a hybrid vehicle to which the present invention is applied.

FIG. 2 is a collinear diagram representing relative relationship of rotation speed of the rotating elements in the power distribution mechanism included in the vehicle power transmission device.

FIG. 3 is a collinear diagram representing correlation of the rotating elements in terms of the planetary gear devices making up the automatic transmission included in the vehicle power transmission device.

FIG. 4 is a functional block diagram for explaining a main portion of a control function of the electronic control device.

FIG. 5 is a diagram for explaining the equal power shift and the non-equal power shift by using a collinear diagram, taking an upshift of the automatic transmission as an example.

FIG. 6 is an example of the equal power shift time inertia torque map.

FIG. 7 is an example of the non-equal power shift time inertia torque map.

FIG. 8 is a flowchart for explaining a main portion of control operation of the electronic control device, i.e., control operation for implementing a proper shift with a shift shock suppressed in the same type of shift in the automatic transmission.

FIG. 9 is a time chart depicting an example in the case of execution of the control operation depicted in the flowchart of FIG. 8 and depicts an example at the time of the equal power shift.

FIG. 10 is a time chart depicting an example in the case of execution of the control operation depicted in the flowchart of FIG. 8 and depicts an example at the time of the non-equal power shift.

FIG. 11 is a time chart depicting an example in the case of execution of the control operation depicted in the flowchart of FIG. 8 and depicts another example at the time of the non-equal power shift.

### MODE FOR CARRYING OUT THE INVENTION

In the present invention, preferably, the mechanical shift mechanism is made up of various planetary gear multistage transmissions (i.e., stepped automatic transmissions) having, for example, one set or a plurality of sets of rotating members of a planetary gear device selectively coupled by engagement devices to achieve a plurality of gear stages (shift stages) in an alternative manner and having, for example, two forward speeds, three forward speeds, or more shift stages. For the engagement devices, hydraulic friction engagement devices are widely used, such as multi-plate and single-plate clutches and brakes engaged by hydraulic actuators or belt type brakes. Although an oil pump supplying operating oil for engagement actuation of the hydraulic friction engagement devices may be, for example, an oil pump rotationally driven by an engine that is a drive power source for running to discharge the operating oil, the oil pump may be rotationally driven by a dedicated electric motor etc., disposed separately from the engine.

Preferably, it is desirable in terms of responsiveness that, for example, a hydraulic control circuit including the hydraulic friction engagement devices directly supplies an output oil pressure of a solenoid valve to each of the hydraulic actuators (hydraulic cylinders) of the hydraulic friction engagement devices; however, the output oil pressure of the solenoid valve can be used as a pilot oil pressure to control a shift control valve such that the operating oil is supplied from the shift control valve to the hydraulic actuators.

Preferably, a mounting posture of the vehicle power transmission device relative to a vehicle may be of a transversely mounted type as in the case of FF (front-engine front-drive) vehicles in which an axis of a drive device is in the width direction of the vehicle or a longitudinally mounted type as in the case of FR (front-engine rear-drive) vehicles in which the axis of the drive device is in the longitudinal direction of the vehicle.

Preferably, the engine and the differential mechanism may operatively be coupled in any manner and, for example, the engine and the differential mechanism may have a pulsation absorbing damper (vibration damping device), a direct clutch, a direct clutch with a damper, or a hydraulic power transmission device interposed therebetween, or the engine and the differential mechanism may always be coupled. A torque converter with a lockup clutch, a fluid coupling, etc., are used as the hydraulic power transmission device.

The phrase “supplying an oil pressure” as used herein means “causing an oil pressure to act on” or “supplying operating oil controlled to the oil pressure”. The term “rotation number” as used herein means a “rotation number per unit time”, i.e., “rotation speed (rpm)”. For example, an engine rotation number means an engine rotation speed and a rotation number time change rate means a rotation speed time change rate.

An example of the present invention will now be described in detail with reference to the drawings.

### EXAMPLE

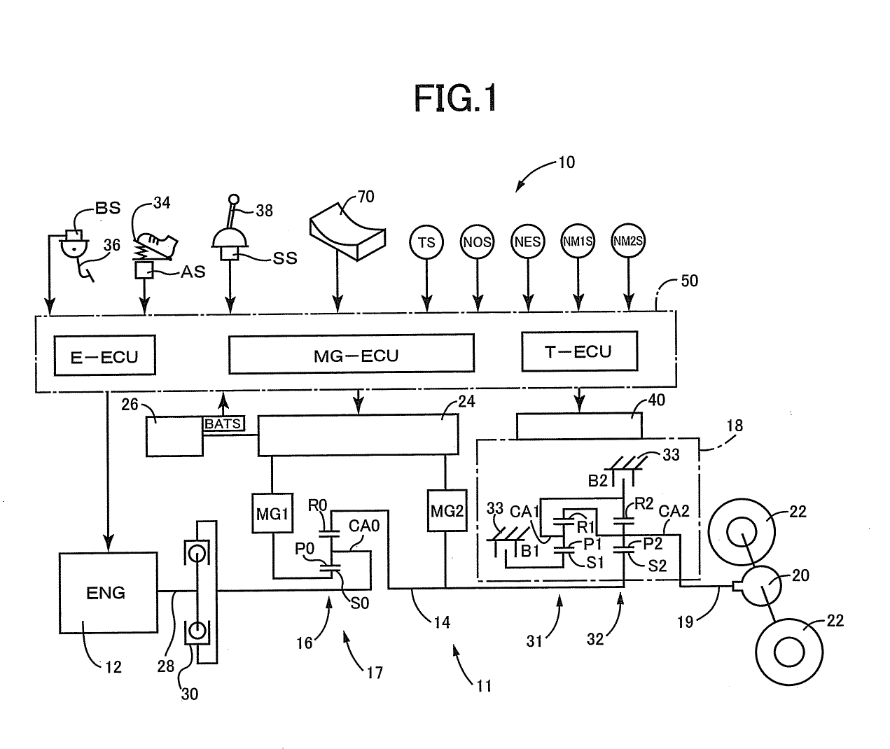

FIG. 1 is a diagram for explaining a hybrid vehicle (hereinafter, the vehicle) 10 to which the present invention is preferably applied. The vehicle 10 depicted in FIG. 1 includes a vehicle power transmission device (hereinafter, the power transmission device) 11 having a power distribution mechanism 16 distributing power output from an engine 12 to a first electric motor MG1 acting as a differential electric motor and a transmitting member 14 acting as an output rotation member, a second electric motor MG2 acting as an electric motor for running coupled to the transmitting member 14 in an operable manner (in a power transmittable manner), and an automatic transmission 18 acting as a mechanical shift mechanism making up a portion of a power transmission path between the power distribution mechanism 16 (transmitting member 14) and drive wheels 22. The power transmission device 11 is preferably used in an FR (front-engine rear-drive) vehicle etc., and torque output from the engine 12 and the second electric motor MG2 is transmitted to the transmitting member 14 so that the torque is transmitted from the transmitting member 14 via the automatic transmission 18 and a differential gear device 20 to a pair of the left and right rear wheels (the drive wheels) 22. Since the power transmission device 11 is symmetrically configured relative to a center line, the lower half thereof is not depicted in FIG. 1.

The vehicle 10 includes an electronic control device 50 including a control device providing various controls of the power transmission device 11, for example. The electronic control device 50 includes a so-called microcomputer including a CPU, a RAM, a ROM, and an I/O interface, for example, and the CPU executes signal processes in accordance with programs stored in advance in the ROM, while utilizing a temporary storage function of the RAM, to provide various controls of the vehicle 10. For example, the electronic control device 50 provides the output control of the engine 12, the output controls including regenerative control of the first electric motor MG1 and the second electric motor MG2, the shift control of the automatic transmission 18, etc., and is configured separately as needed as an engine-control electronic control device (E-ECU), a motor-generator-control electronic control device (MG-ECU), a transmission-control electronic control device (T-ECU), etc.

The engine 12 is a main power source of the vehicle 10 and is a known internal combustion engine combusting predetermined fuel to output power, such as a gasoline engine and a diesel engine, for example. The engine 12 has an operational state, such as a throttle opening degree or an intake air amount, a fuel supply amount, and ignition timing, electrically controlled by, for example, the engine-control electronic control device (E-ECU) so that an output torque (engine torque) T_{E} of the engine 12 is controlled.

The first electric motor MG1 and the second electric motor MG2 are, for example, synchronous electric motors having at least one of a function of an electric motor (motor) generating a drive torque and a function of an electric generator (generator) and are motor generators selectively actuated as a motor or an electric generator, for example. The first electric motor MG1 and the second electric motor MG2 are connected via, for example, an inverter 24 to an electric storage device 26 such as a battery and a capacitor and the inverter 24 is controlled by the motor-generator-control electronic control device (MG-ECU) so as to control respective output torques or regenerative torques (MG1 torque T_{MG1} and MG2 torque T_{MG2}) of the first electric motor MG1 and the second electric motor MG2.

The power distribution mechanism 16 is made up of a known single pinion type planetary gear device including a sun gear S0, a ring gear R0 disposed concentrically to the sun gear S0, and a carrier CA0 supporting a pinion gear P0 meshing with the sun gear S0 and the ring gear R0 in a rotatable and revolvable manner as three rotating elements (rotating members) and acts as a differential mechanism generating a differential action. The planetary gear device is disposed concentrically to the engine 12 and the automatic transmission 18. In the power transmission device 11, a crankshaft 28 of the engine 12 is coupled via a damper 30 to the carrier CA0 of the power distribution mechanism 16. On the other hand, the sun gear S0 is coupled to the first electric motor MG1, and the ring gear R0 is coupled to the transmitting member 14. In the power distribution mechanism 16, the carrier CA0, the sun gear S0, and the ring gear R0 act as an input element, a reaction force element, and an output element, respectively.

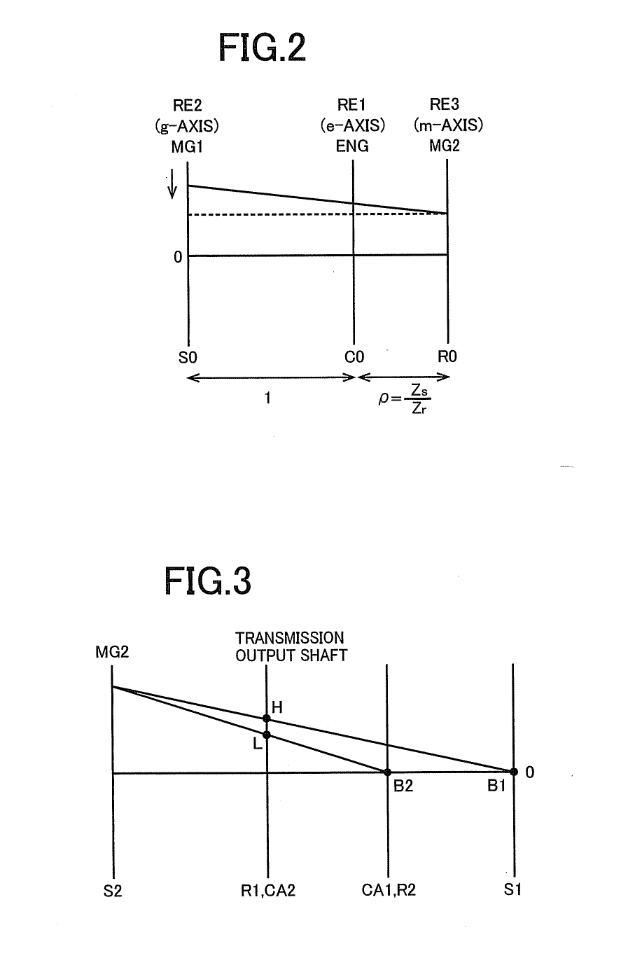

Relative relationship of rotation speed of the rotating elements in the power distribution mechanism 16 is represented by a collinear diagram of FIG. 2. In this collinear diagram, a vertical axis S (g-axis), a vertical axis CA (e-axis), and a vertical axis R (m-axis) are axes indicative of a rotation speed of the sun gear S0, a rotation speed of the carrier CA0, and a rotation speed of the ring gear R0, respectively, and mutual intervals of the vertical axis S, the vertical axis CA, and the vertical axis R are set such that when an interval between the vertical axis S and the vertical axis CA is defined as one, an interval between the vertical axis CA and the vertical axis R is set to p (i.e., a gear ratio ρ of the power distribution mechanism 16=a teeth number Zs of the sun gear S0/a teeth number Zr of the ring gear R0). If a reaction torque, i.e., a negative torque from the first electric motor MG1, is input to the sun gear S0 in positive rotation relative to the engine torque T_{E} input to the carrier CA0 in the power distribution mechanism 16, an output torque occurs as a positive torque in positive rotation in the ring gear R0 acting as the output element. In this case, the first electric motor MG1 generating the negative torque in positive rotation acts as an electric generator. Therefore, an electric continuously variable transmission 17 (see FIG. 1) is configured as an electric shift mechanism (electric differential mechanism) including the power distribution mechanism 16 having three rotating elements, which are the carrier CA0 acting as a first rotating element RE1 coupled to the engine 12 in a power transmittable manner, the sun gear S0 acting as a second rotating element RE2 coupled to the first electric motor MG1 in a power transmittable manner, and the ring gear R0 acting as a third rotating element RE3 that is an output rotating member coupled to the second electric motor MG2 in a power transmittable manner, such that a differential state of the power distribution mechanism 16 is controlled by controlling the operational state of the first electric motor MG1. In short, the electric continuously variable transmission 17 is configured that has the power distribution mechanism 16 acting as a differential mechanism coupled to the engine 12 in a power transmittable manner and the first electric motor MG1 acting as a differential electric motor coupled to the power distribution mechanism 16 in a power transmittable manner such that the differential state of the power distribution mechanism 16 is controlled by controlling the operational state of the first electric motor MG1. Therefore, the electric continuously variable transmission 17 is allowed to operate as an electric continuously variable transmission with a gear ratio γ0 (=a rotation speed N_{E} of the engine 12/a rotation speed N₁₄ of the transmitting member 14) continuously varied. The power of the engine 12 is transmitted via the electric continuously variable transmission 17 to the transmitting member 14.

The electric continuously variable transmission 17 can continuously (steplessly) vary the engine rotation speed N_{E} that is the rotation speed of the engine 12 by increasing or decreasing a first electric motor rotation speed N_{MG1} that is the rotation speed of the first electric motor MG1 regardless of the rotation speed of the ring gear R0 through the control of the differential state of the power distribution mechanism 16. A broken line of FIG. 2 indicates that while the rotation speed of the ring gear R0 is constant, the engine rotation speed N_{E} is reduced by reducing the first electric motor rotation speed N_{MG1} from a value indicated by a solid line. Since the power distribution mechanism 16 is allowed to act as a continuously variable transmission by controlling the first electric motor MG1, the engine 12 can be operated along an operating point of the engine 12 (e.g., operational point of the engine 12 defined by the engine rotation speed N_{E} and the engine torque T_{E}; hereinafter referred to as an engine operating point) at which the best fuel efficiency is achieved, for example. This type of hybrid form is referred to as a mechanical distribution type or a split type.

Returning to FIG. 1, the automatic transmission 18 is mainly made up of two planetary gear devices 31 and 32 and disposed in a power transmission path between the electric continuously variable transmission 17 (the transmitting member 14 that is the output rotating member of the electric continuously variable transmission 17) and the drive wheels 22 and in series with the electric continuously transmission 17 and the drive wheels 22, and the two planetary gear devices 31 and 32 have rotating elements coupled to each other, for example. Concretely, the automatic transmission 18 includes the single pinion type planetary gear device 31 including a sun gear S1, a ring gear R1, and a carrier CA1 supporting a pinion gear P1 in a rotatable and revolvable manner as three rotating elements to generate a known differential action and the single pinion type planetary gear device 32 including a sun gear S2, a ring gear R2, and a carrier CA2 supporting a pinion gear P2 in a rotatable and revolvable manner as three rotating elements to generate a known differential action, and the carrier CA1 and the ring gear R2 are coupled to each other while the ring gear R1 and the carrier CA2 are coupled to each other. The sun gear S2 is coupled to the transmitting member 14, and the ring gear R1 and the carrier CA2 are coupled to a transmission output shaft (AT output shaft) 19 that is an output rotating member of the automatic transmission 18. The transmitting member 14 acts as a transmission input shaft (AT input shaft) that is an input rotating member of the automatic transmission 18.

The automatic transmission 18 is disposed with a plurality of engagement devices (engagement elements) for selectively establishing a plurality of shift stages having respective different gear ratios in the automatic transmission 18. Concretely, the automatic transmission 18 is disposed with a first brake B1 disposed between the sun gear S1 and a housing 33 that is a non-rotating member for selectively fixing the sun gear S1 and a second brake B2 disposed between the carrier CA1/the ring gear R2 and the housing 33 for selectively fixing the carrier CA1 and the ring gear R2 coupled to each other. The first brake B1 and the second brake B2 are so-called friction engagement devices generating a braking force from a friction force and are made up of, for example, wet multi-plate type hydraulic friction engagement devices in which a plurality of friction plates overlapped with each other is pressed by hydraulic actuators so as to selectively couple members on the both sides of the brakes interposed therebetween. The automatic transmission 18 is configured such that the respective torques capacities, i.e., clutch torques (engagement torques) Tb1 and Tb2 of the first brake B1 and the second brake B2 are continuously varied depending on an oil pressure (engagement pressure, clutch pressure) of operating oil supplied from a hydraulic control circuit 40 for actuating the first brake B1 and the second brake B2.

In the automatic transmission 18 configured as described above, when the first brake B1 is engaged, a high-speed stage H is achieved with a gear ratio γ_{AT}h that is a gear ratio γ_{AT} of the automatic transmission 18 (=rotation speed N_{AT} of the AT input shaft/rotation speed N_{OUT} of the AT output shaft 19) greater than “1”. When the second brake B2 is engaged instead of the first brake B1, a low-speed stage L is achieved with a gear ratio γ_{AT}1 that is a gear ratio γ_{AT} of the automatic transmission 18 greater than the gear ratio γ_{AT}h of the high-speed stage H. Therefore, the automatic transmission 18 is a mechanical shift mechanism having a shift stage established by controlling supply/discharge of the operating oil to the hydraulic friction engagement devices, i.e., having a shift stage switched by engagement and release of the hydraulic friction engagement devices. A shift between the shift stages H and L is performed based on a running state such as a vehicle speed and a requested drive power related value (target drive power related value). More specifically, the transmission-control electronic control device (T-ECU) establishes any of the shift stages based on an actual running state from a known relationship (shift diagram, shift map) obtained and stored in advance having a shift line for selecting a shift stage. A drive power related value of the requested drive power related value is a value corresponding one-to-one to the drive power of the vehicle and may be not only the drive torque or the drive power on the drive wheels 22 but also an output torque of the automatic transmission 18, i.e., an AT output shaft torque T_{OUT} that is the torque on the AT output shaft 19, the engine torque T_{E}, or vehicle acceleration, for example. The requested drive power related value is a requested value (target value) of the drive power related value determined based on, for example, an accelerator opening degree (or a throttle valve opening degree, an intake air amount, an air-fuel ratio, a fuel injection amount); however, the accelerator opening degree, etc., may directly be used.

FIG. 3 is a collinear diagram having four vertical axes S2, R11/CA2, CA1/R2, and S1 for representing correlation of the rotating elements in terms of the planetary gear devices 31 and 32 making up the automatic transmission 18. The vertical axes S2, R1/CA2, CA1/R2, and S1 indicate the rotation speed of the sun gear S2, the rotation speed of the ring gear R1 and the carrier CA2 coupled to each other, the rotation speed of the carrier CA1 and the ring gear R2 coupled to each other, and the rotation speed of the sun gear S1, respectively. As depicted in this collinear diagram, in the automatic transmission 18, when the carrier CA1 and the ring gear R2 are fixed by the second brake B2, the low-speed stage L is formed, and a torque of the transmitting member 14, i.e., an AT input shaft torque T_{AT} defined as a torque on the AT input shaft is increased depending on the gear ratio γ_{AT}1 at this point and is transmitted to the AT output shaft 19. If the first sun gear S1 is fixed by the first brake B1 instead, the high-speed stage H is formed that has the gear ratio γ_{AT} smaller than the gear ratio γ_{AT}1 of the low-speed stage L. Since the gear ratio of the high-speed stage H is larger than “1”, the AT input shaft torque T_{AT} is increased depending on the gear ratio γ_{AT}1 and is transmitted to the AT output shaft 19. While each of the shift stages L and H is steadily formed, the torque transmitted to the AT output shaft 19 (i.e., the AT output shaft torque T_{OUT}) is a torque acquired by increasing the AT input shaft torque T_{AT} depending on each of the gear ratios; however, in a shift transition state of the automatic transmission 18, the torque is affected by a torque capacity of each of the brakes B1 and B2, an inertia torque associated with a rotation speed change, etc.

Returning to FIG. 1, the electronic control device 50 is supplied with detection signals from, for example, an accelerator opening degree sensor AS detecting an accelerator operation amount (accelerator opening degree) Acc that is an operation amount of an accelerator pedal 34, a brake sensor BS for detecting an operation of a brake pedal 36, an operation position sensor SS for detecting an operation position (shift position) P_{SH} of a shift lever 38, an oil temperature sensor TS for detecting a temperature (operating oil temperature) TH_{OIL} of the operating oil, an output rotation speed sensor NOS for detecting the AT output shaft rotation speed N_{OUT} that is the rotation speed of the AT output shaft 19 corresponding to a vehicle speed V, an engine rotation speed sensor NES for detecting the engine rotation speed N_{E}, a first electric motor rotation speed sensor NM1S for detecting the first electric motor rotation speed N_{MG1}, a second electric motor rotation speed sensor NM2S for detecting a second electric motor rotation speed N_{MG2} that is a rotation speed of the second electric motor MG2 (i.e., an AT input shaft rotation speed N_{AT} that is the rotation speed N_{AT} of the AT input shaft defined as the rotation speed N₁₄ of the transmitting member 14), and a battery state detection sensor BATS for detecting a temperature (electric storage device temperature) THbat, a charging current or a discharging current (charging/discharging current or input/output current) Icd, and a voltage (electric storage device voltage) Vbat of the electric storage device 26. A charged capacity (a state of charge, a charge level) SOC of the electric storage device 26 is calculated based on the electric storage device temperature THbat, the charging/discharging current Icd, and the electric storage device voltage Vbat.

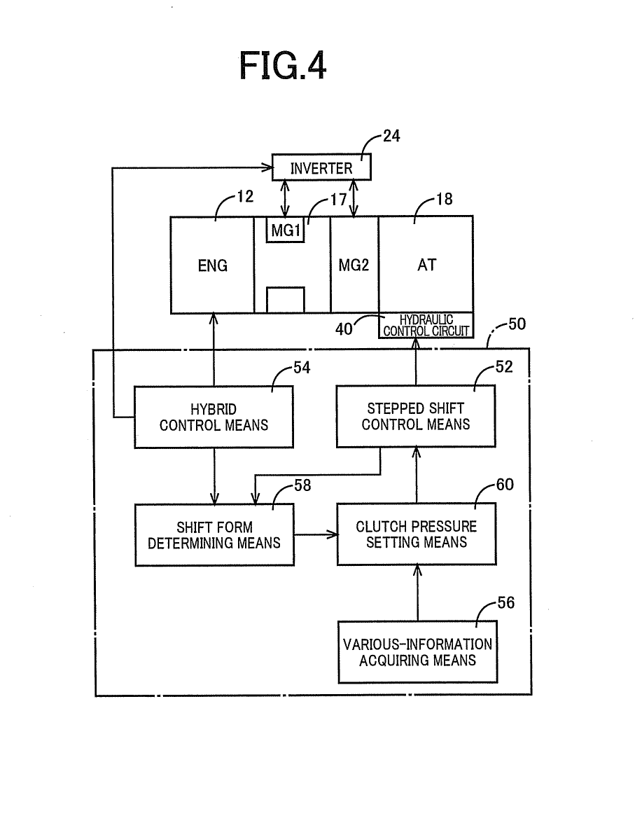

FIG. 4 is a functional block diagram for explaining a main portion of a control function of the electronic control device 50. In FIG. 4, a stepped shift control portion, i.e., a stepped shift control means 52 provides the shift control of the automatic transmission 18. The stepped shift control means 52 makes a shift determination based on a running state of the vehicle 10, for example, the vehicle speed V and the accelerator operation amount Acc (or the AT output shaft torque T_{OUT} etc.) from, for example, a predetermined known relationship (shift diagram, shift map), and outputs to the hydraulic control circuit 40 an instruction/instructions (shift output instruction, oil pressure instruction) for selectively establishing the high-speed stage H or the low-speed stage L in the automatic transmission 18. The hydraulic control circuit 40 engages and/or releases the engagement devices involved in the shift of the automatic transmission 18 such that a shift stage is achieved in accordance with the instruction. For example, if the instruction is an upshift instruction from the low-speed stage L to the high-speed stage H, the hydraulic control circuit 40 actuates hydraulic actuators of the brakes B1 and B2 so as to release the second brake B2 acting as a release-side engagement device and to engage the first brake B1 acting as an engagement-side engagement device.

A hybrid control portion, i.e., a hybrid control means 54 selectively establishes, for example, a motor running mode in which only the second electric motor MG2 is used as a drive source with the engine 12 stopped; an engine running mode (steady running mode) in which a reaction force to the power of the engine 12 is received through the electric generation of the first electric motor MG1 to transmit an engine direct torque to the transmitting member 14 while the second electric motor MG2 is driven by the generated electric power of the first electric motor MG1 to transmit a torque to the transmitting member 14 for running; an assist running mode (acceleration running mode) in which the drive power of the second electric motor MG2 using electric power from the electric storage device 26 is further added for running in the engine running mode, etc., depending on a running state.

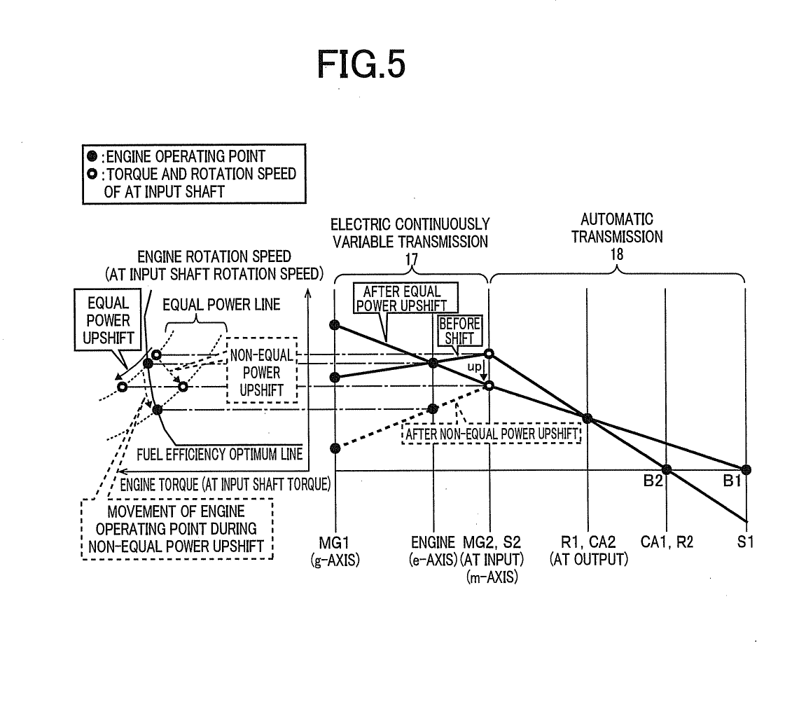

The control in the engine running mode will specifically be described as an example. The hybrid control means 54 provides the control of the engine 12 and the electric motors MG in consideration of a shift stage of the automatic transmission 1.8 for power performance, improvement in fuel efficiency, etc. In such hybrid control, the electric continuously variable transmission 17 is allowed to act as an electric continuously variable transmission so as to match the engine rotation speed N_{E} determined for operating the engine 12 in an efficient operation range with the AT input shaft rotation speed N_{AT} determined by the vehicle speed V and the shift stage of the automatic transmission 18. For example, the hybrid control means 54 calculates requested power of the vehicle 10 from the accelerator opening degree Acc and the vehicle speed V and calculates necessary total target power from the requested power and a charge request value. The hybrid control means 54 further calculates target engine power P_{E}* that is a target value of output power (engine power) P_{E} of the engine 12 such that the total target power is acquired in consideration of a transmission loss, an accessory load, an assist torque of the second electric motor MG2, etc. The hybrid control means 54 controls the engine 12 and controls an amount of electric generation of the first electric motor MG1 so as to achieve an engine operating point at which the target engine power P_{E}* can be acquired while operating the engine 12 along a known engine fuel efficiency optimum line (see FIG. 5) stored in advance for satisfying both the drivability and the fuel efficiency property, for example. In this example, fuel efficiency refers to, for example, a running distance per unit fuel consumption, or a fuel consumption rate (=fuel consumption/drive wheel output) of a vehicle as a whole.

Although a main portion of the power of the engine 12 is mechanically transmitted to the transmitting member 14 in the hybrid control, a portion of the power of the engine 12 is converted into electric energy through the electric generation by the first electric motor MG1 and the electric energy is supplied through the inverter 24 to the second electric motor MG2 and the electric storage device 26. The second electric motor MG2 is driven by the electric power from the first electric motor MG1 and the electric storage device 26, and the power from the second electric motor MG2 is applied to the transmitting member 14. The equipment related to electric energy from the generation by the first electric motor MG1 involved in electric generation to the consumption by the second electric motor MG2 involved in driving makes up an electric path from the conversion of a portion of the power of the engine 12 into electric energy to the conversion of the electric energy into mechanical energy.

The vehicle power transmission device 11 of this example enables each of the electric continuously variable transmission 17 and the automatic transmission 18 to perform a shift. Therefore, in a concurrent shift such as when the shift control of the electric continuously variable transmission 17 and the shift control of the automatic transmission 18 are provided at the same time (in parallel), it is desirable to provide shift control in consideration of an overall balance in anticipation of an energy balance etc., of the whole shift mechanism consisting of the electric continuously variable transmission 17 and the automatic transmission 18 (the whole vehicle power transmission device 11). Specifically, main factors related to the energy balance at the time of shift of the whole vehicle power transmission device 11 are four factors, which are, for example, the generated power of the engine 12 (engine power P_{E}), the power output as drive power from the AT output shaft 19 (drive transmission power through the brakes B1 and B2), the inertia energy associated with a rotation change in a rotating member, and the electric power balance of the electric storage device 26 (charge/discharge balance, i.e., charge/discharge amount of the electric storage device 26). Therefore, the charge/discharge balance of the electric storage device 26 can be controlled to a target value by the engine power P_{E}, the drive transmission power through the brakes B1 and B2, and the inertia energy.

The target value of the charge/discharge balance of the electric storage device 26 is calculated based on, for example, the running state of the vehicle 10 and the charged capacity SOC of the electric storage device 26. For example, the target value of the charge/discharge balance is zero (±0 [kw]) if no charge/discharge request is made to the electric storage device 26, and is appropriately determined as about 5 [kw] when a charge request is made, about −5 [kw] when a discharge request is made, etc., depending on a charge/discharge status of a system. The drive transmission power through the brakes B1 and B2 is clutch power transmitted toward the drive wheels 22 in the automatic transmission 18 through clutch torques Tb1 and Tb2 of the brakes B1 and B2 (e.g., combined torque of the first brake B1 and the second brake B2 in transition during a shift converted into terms of the m-axis) and is the drive transmission power in the automatic transmission 18 corresponding to power transmitted via the automatic transmission 18 toward the drive wheels 22. In terms of the energy balance of the whole vehicle power transmission device 11, the power balance related to the first electric motor MG1 and the second electric motor MG2 appears in the form of the electric power balance with the electric storage device 26 and therefore may not be considered in this case.

In a form of the concurrent shift of the electric continuously variable transmission 17 and the automatic transmission 18, for example, an equal power shift can be performed in which the automatic transmission 18 is shifted without changing the engine power P_{E} before and after the shift while the movement of the engine operating point is suppressed (e.g., while the engine operating point is fixed). In another form of the concurrent shift, a non-equal power shift can be performed in which the automatic transmission 18 is shifted while the engine power P_{E} is changed before and after the shift by moving the engine operating point. The equal power shift is assumed to occur at the time of an upshift of the automatic transmission 18 associated with an increase in the vehicle speed V in a substantially constant state of the accelerator opening degree Acc and a downshift of the automatic transmission 18 associated with a decrease in the vehicle speed V during deceleration running with acceleration turned off, for example. The non-equal power shift is assumed to occur at the time of an upshift of the automatic transmission 18 associated with a returning operation of the accelerator pedal 34 and a downshift of the automatic transmission 18 associated with an additional depressing operation of the accelerator pedal 34, for example. The equal or non-equal power shift is assumed to occur at the time of shift of the automatic transmission 18 when a shift form selection switch 70 (FIG. 1) capable of selection between the equal power shift and the non-equal power shift through a user operation is included and either the equal power shift or the non-equal power shift is selected via the shift form selection switch 70 through a user operation, for example.

FIG. 5 is a diagram for explaining the equal power shift and the non-equal power shift by using a collinear diagram, taking an upshift of the automatic transmission 18 as an example. In FIG. 5, in the equal power shift, as indicated by a solid line, an upshift of the automatic transmission 18 is performed along with a shift of the electric continuously variable transmission 17 for preventing the movement of the engine operating point. In the non-equal power shift, as indicated by a broken line, an upshift of the automatic transmission 18 is performed along with a shift of the electric continuously variable transmission 17 for changing the engine power P_{E} while the engine operating point is moved along the fuel efficiency optimum line.

As described above, the vehicle power transmission device 11 of this example can perform a shift with a relatively small change in the engine rotation speed N_{E} before and after the shift as in the equal power shift and a shift with a relatively large change in the engine rotation speed N_{E} before and after the shift as in the non-equal power shift in the same type of shift in the automatic transmission 18. Therefore, considering that the inertia of the engine 12 is significantly larger than the inertia of the electric motors MG1, MG2 and the automatic transmission 18, inertia power to be absorbed by the whole vehicle power transmission device 11 is considerably smaller in the equal power shift suppressing the change in the engine rotation speed N_{E} as small as possible, as compared to the non-equal power shift. Therefore, in the same type of shift in the automatic transmission 18, an inertia change amount of the whole vehicle power transmission device 11 generated during a shift of the automatic transmission 18 cannot uniquely be determined and even if the clutch pressure of the engagement devices in transition during a shift is simply set based on the engine torque T_{E}, excessive or insufficient clutch pressure may be generated relative to a shared torque to be received by each of the engagement device. As a result, the shift of the automatic transmission 18 may not properly proceed, resulting in a shift shock. The same type of shift in the automatic transmission 18 refers to shifts of the same shift type in the automatic transmission 18. The shift type refers to a type specified by a shift direction and a shift stage, for example, an upshift from one to two or a downshift from two to one.

Therefore, in this example, a differential torque Tina is made smaller between the engine torque T_{E} and the engagement torque of the engagement devices involved in the shift of the automatic transmission 18 on the same shaft at the time of shift with a smaller change in the engine rotation speed N_{E} as compared to the time of shift with a larger change in the engine rotation speed N_{E} in the same type of shift in the automatic transmission 18. For example, a clutch torque value Tb of the engagement devices converted into terms of the m-axis (AT input shaft) as a combined value of the respective clutch torques Tb1 and Tb2 of the first brake B1 and the second brake B2 is a total torque acquired by adding a shift time inertia torque Tina as the differential torque Tina on the AT input shaft to the AT input shaft torque T_{AT}. Therefore, this total torque is a combined torque of the shared torques Tb1 and Tb2 converted into terms of the AT input shaft to be received by the engagement-side engagement device and the release-side engagement device, respectively, with respect to the total torque. This shift time inertia torque Tina is made smaller at the time of the equal power shift as compared to the non-equal power shift in the same type of shift in the automatic transmission 18.

More specifically, a various-information acquiring portion, i.e., a various-information acquiring means 56 acquires, for example, a type of a shift of the automatic transmission 18 performed by the stepped shift control means 52. The various-information acquiring means 56 acquires, for example, the vehicle speed V. The various-information acquiring means 56 acquires, for example, the AT input shaft torque T_{AT}. The AT input shaft torque T_{AT} is a combined torque of a mechanically transmitted engine direct torque T_{D} (=T_{R}/(1+ρ)) and the MG2 torque T_{MG2} driven by electric power transmitted via the electric path. If the charge/discharge balance of the electric storage device 26 is zero, since substantially all of the generated electric power of the first electric motor MG1 is transmitted to the second electric motor MG2 and the second electric motor MG2 is driven only by the generated electric power, the AT input shaft torque T_{AT} corresponds to the engine torque T_{E} transmitted to the AT input shaft, i.e., the combined torque of a distributed torque mechanically transmitted as the engine direct torque T_{D} and a distributed torque electrically transmitted from the first electric motor MG1 via the electric path to the second electric motor MG2. The various-information acquiring means 56 acquires an instruction for the equal power shift or an instruction for the non-equal power shift from a user, for example, based on a signal from the shift form selection switch 70.

A shift form determining portion, i.e., a shift form determining means 58 determines whether a shift form of the whole vehicle power transmission device 11 at the time of shift of the automatic transmission 18 by the stepped shift control means 52, i.e., a form of the concurrent shift, is the equal power shift or the non-equal power shift. For example, the shift form determining means 58 determines whether the form is the equal power shift or the non-equal power shift based on a change in the accelerator opening degree Acc and a user operation of the shift form selection switch 70.

If the shift form determining means 58 determines that the form is the equal power shift, a clutch pressure setting portion, i.e., a clutch pressure setting means 60 selects a relationship (equal power shift time inertia torque map) acquired by empirically obtaining and storing values of the shift time inertia torque Tina used at the time of the equal power shift. If the shift form determining means 58 determines that the form is the non-equal power shift, the clutch pressure setting means 60 selects a relationship (non-equal power shift time inertia torque map) acquired by empirically obtaining and storing values of the shift time inertia torque Tina used at the time of the non-equal power shift. The equal power shift time inertia torque map and the non-equal power shift time inertia torque map are set for each shift type of the automatic transmission 18, for example.

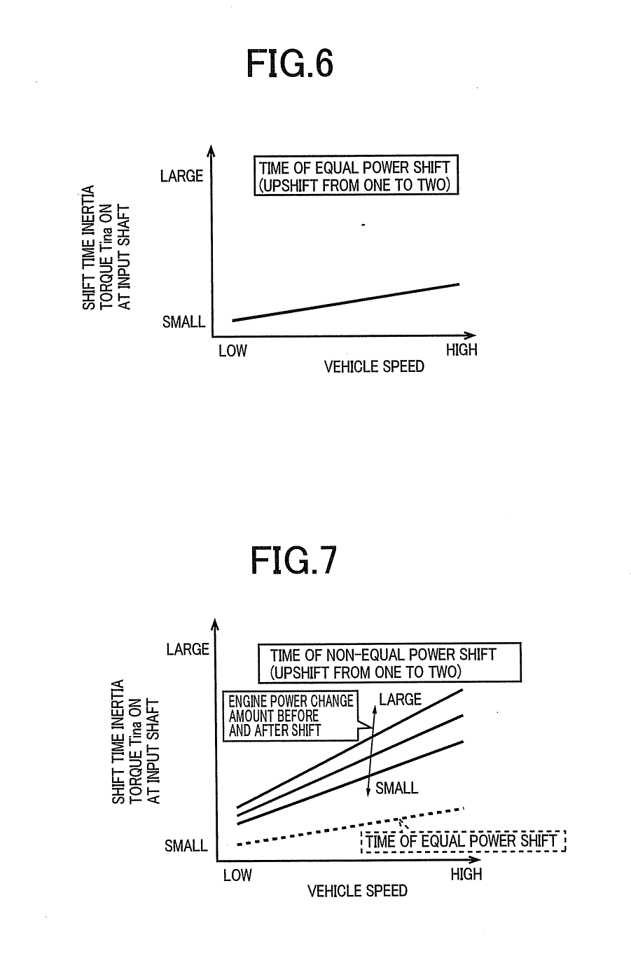

FIG. 6 depicts an example of the equal power shift time inertia torque map at the time of the upshift from one to two and, when the vehicle speed V is higher, the shift time inertia torque Tina on the AT input shaft is made larger. FIG. 7 depicts an example of the non-equal power shift time inertia torque map at the time of the upshift from one to two; the shift time inertia torque Tina on the AT input shaft is set to a larger value than the shift time inertia torque Tina in the equal power shift time inertia torque map at the same vehicle speed V; and the change gradient of the shift time inertia torque Tina is made larger when the vehicle speed V is higher, and is set to a higher value as compared to the change gradient of the shift time inertia torque Tina in the equal power shift time inertia torque map. As described above, the shift time inertia torque Tina is a value set in advance for each of the time of the equal power shift and the time of the non-equal power shift. Particularly, at the time of the non-equal power shift, when a change amount of the engine power P_{E} before and after the shift is larger (e.g., a change amount of the accelerator opening degree Acc is larger), a movement amount of the engine operating point becomes larger. If the movement of the engine operating point at the time of the non-equal power shift is associated with a change in the engine rotation speed N_{E}, when a change amount of the engine power P_{E} before and after the shift is larger, a change in the engine rotation speed N_{E} before and after the shift also becomes lager. When a change in the engine rotation speed N_{E} before and after the shift is larger, the shift time inertia torque Tina becomes larger. Therefore, at the time of the non-equal power shift associated with a change in the engine rotation speed N_{E}, as depicted in FIG. 7, when a change amount of the engine power P_{E} before and after the shift is larger, the shift time inertia torque Tina is made larger.

The clutch pressure setting means 60 calculates the shift time inertia torque Tina on the AT input shaft based on the type of shift of the automatic transmission 18, the vehicle speed V, etc., using the equal power shift time inertia torque map or the non-equal power shift time inertia torque map selected. The clutch pressure setting means 60 calculates a total toque acquired by adding the calculated shift time inertia torque Tina to the AT input shaft torque T_{AT} acquired by the various-information acquiring means 56, as the clutch torque value Tb of the engagement devices converted into terms of the AT input shaft. The clutch pressure setting means 60 calculates the shared torques Tb1 and Tb2 to be received by the engagement-side engagement device and the release-side engagement device, respectively, with respect to the total torque and sets the respective oil pressure instruction values of the first brake B1 and the second brake B2.

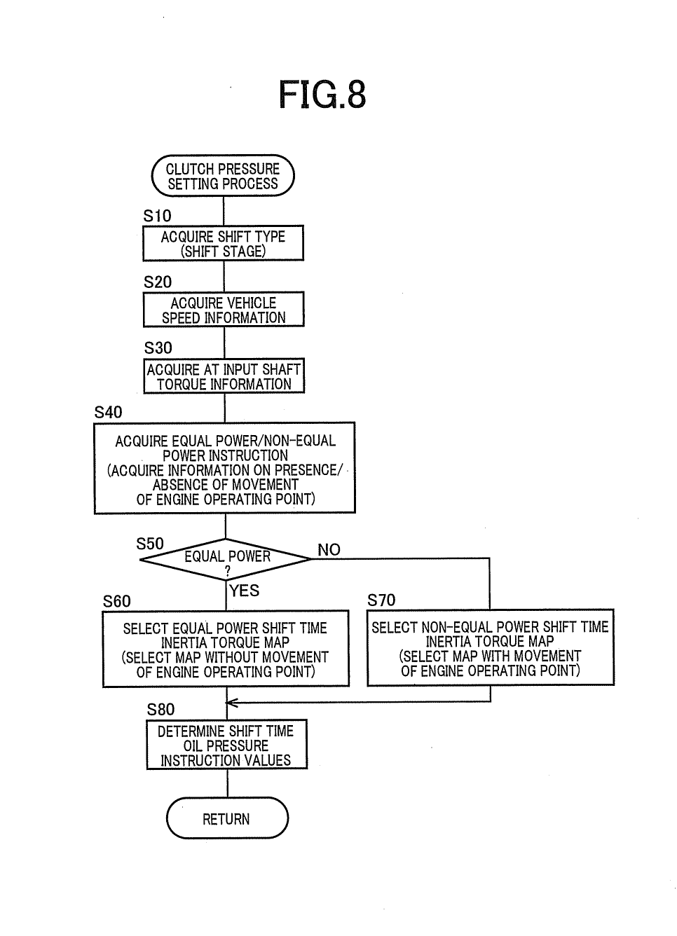

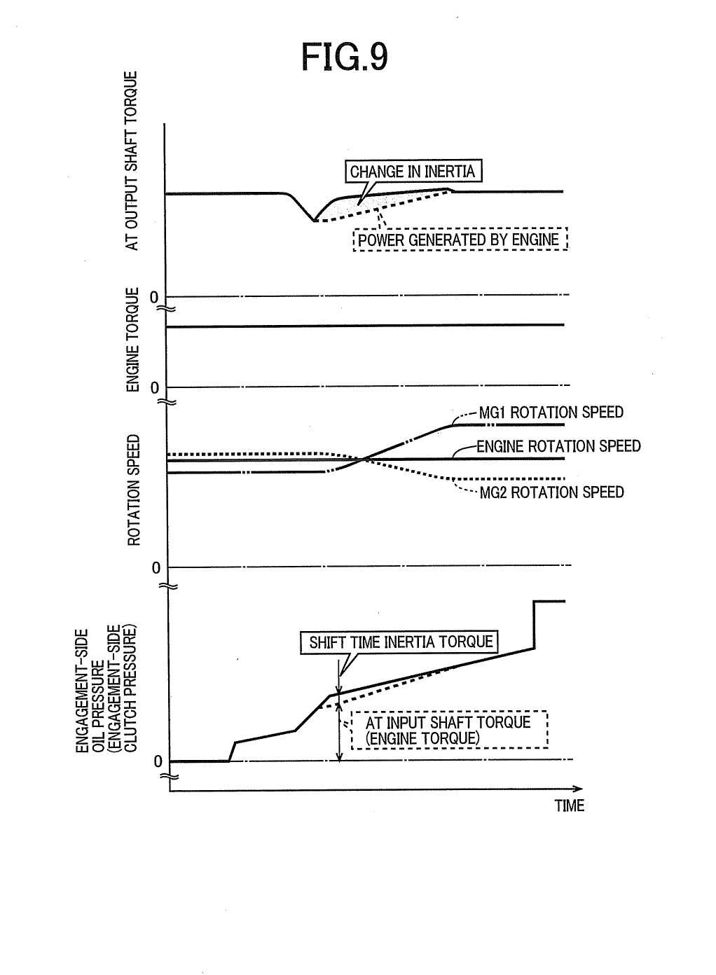

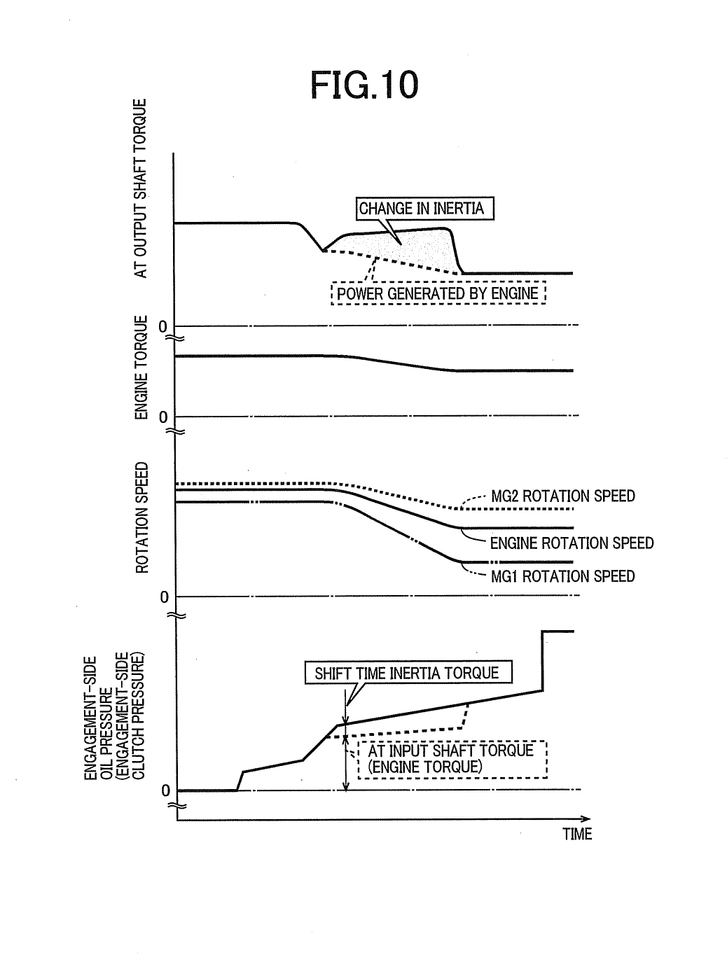

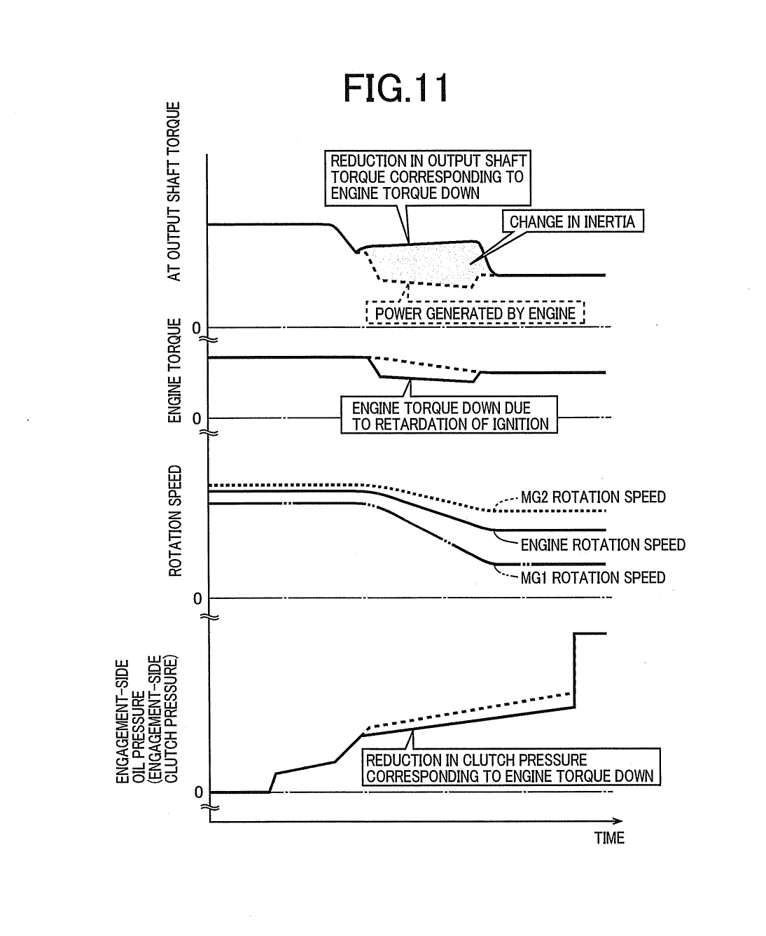

FIG. 8 is a flowchart for explaining a main portion of control operation of the electronic control device 50, i.e., control operation for implementing a proper shift with a shift shock suppressed in the same type of shift in the automatic transmission 18 and is repeatedly executed with an extremely short cycle time, for example, on the order of a few msec to a few tens of msec. Each of FIGS. 9 to 11 is a time chart in the case of execution of the control operation depicted in the flowchart of FIG. 8. FIG. 9 depicts an example at the time of the equal power shift for the upshift of the automatic transmission 18 and each of FIGS. 10 and 11 depicts an example at the time of the non-equal power shift for the upshift of the automatic transmission 18. The start time point of the flowchart of FIG. 8 is assumed to be the start of shift control of the automatic transmission 18, for example.

In FIG. 8, first, at steps (hereinafter, step will be omitted) S10 to S40 corresponding to the various-information acquiring means 56, for example, a type of a shift of the automatic transmission 18 and the vehicle speed V are acquired. For example, the engine torque T_{E} is calculated based on the actual engine rotation speed N_{E} and a throttle valve opening degree θ_{TH} from a predetermined known relationship (engine torque map). The MG2 torque T_{MG2} is calculated based on an energization amount supplied from the inverter 24 to the second electric motor MG2. The AT input shaft torque T_{AT} (=T_{D}+T_{MG2}) is then acquired based on the engine direct torque T_{D}(=T_{E}/(1+ρ)) and the MG2 torque T_{MG2}. An instruction for the equal power shift or an instruction for the non-equal power shift from a user is acquired based on a signal from the shift form selection switch 70, for example. Subsequently, at S50 corresponding to the shift form determining means 58, it is determined whether the shift is the equal power shift, based on a change in the accelerator opening degree Acc and the instruction through a user operation of the shift form selection switch 70. If the determination of S50 is affirmative, at S60 corresponding to the clutch pressure setting means 60, the equal power shift time inertia torque map is selected. On the other hand, if the determination of S50 is negative, at S70 corresponding to the clutch pressure setting means 60, the non-equal power shift time inertia torque map is selected. After S60 or S70, at S80 corresponding to the clutch pressure setting means 60, the shift time inertia torque Tina on the AT input shaft is calculated based on the type of shift of the automatic transmission 18, the vehicle speed V, etc., using the equal power shift time inertia torque map or the non-equal power shift time inertia torque map selected. The total toque acquired by adding the calculated shift time inertia torque Tina to the AT input shaft torque T_{AT} acquired at S30 is then calculated as the clutch torque value Tb of the engagement devices converted into terms of the AT input shaft. The shared torques Tb1 and Tb2 to be received by the engagement-side engagement device and the release-side engagement device, respectively, are further calculated with respect to the calculated total torque and the respective oil pressure instruction values of the first brake B1 and the second brake B2 are set.

Comparing FIG. 9 with FIG. 10, the AT output shaft torque T_{OUT} at the time of the equal power shift of FIG. 9 has an effect of a change in inertia (a portion surrounded by a solid line and a broken line) made smaller as compared to the AT output shaft torque T_{OUT} at the time of the non-equal power shift of FIG. 10. Therefore, in the setting of the engagement side clutch pressure, the shift time inertia torque Tina on the AT input shaft corresponding to the change in inertia is made smaller in FIG. 9. Comparing FIG. 10 with FIG. 11, FIG. 11 is mainly different in that reduction control of the engine torque T_{E} is provided due to retardation of ignition etc. Even if such reduction control of the engine torque T_{E} is provided, as depicted in FIG. 11, the concept is the same as when no reduction control of the engine torque T_{E} is provided, with regard to setting the oil pressure instruction values based on the total torque acquired by adding the shift time inertia torque Tina to the AT input shaft torque T_{AT}, i.e., setting the shift time inertia torque Tina based on whether a shift is the equal power shift or the non-equal power shift.

As described above, according to this example, since the differential torque (the shift time inertia torque Tina) between the engine torque T_{E} and the engagement torque of the engagement devices involved in a shift of the automatic transmission 18 on the same shaft is made smaller in a case of a shift with a smaller change in the engine rotation speed N_{E} as compared to a case of a shift with a larger change in the engine rotation speed N_{E} in the same type of shift in the automatic transmission 18, the engagement torque of the engagement devices involved in a shift of the automatic transmission 18 can be set based on an inertia change amount of the engine 12 having the largest inertia in the whole power transmission system including the engine 12. Therefore, a proper engagement torque can be set in consideration of the torque transmission corresponding to the engine torque T_{E} and the shift time inertia torque Tina corresponding to a change in inertia. As a result, a proper shift can be implemented with a shift shock suppressed in the same type of shift in the automatic transmission 18. For example, the occurrence of shift shock etc., can be suppressed while the power balance is controlled to a desired value.

According to this example, the shift time inertia torque Tina is a value set in advance for each of the time of the shift with a smaller change in the engine rotation speed N_{E} and the time of the shift with a larger change in the engine rotation speed N_{E}, the engagement torque of the engagement devices involved in a shift of the automatic transmission 18 can properly be set based on the shift time inertia torque Tina.

According to this example, since the shift with a smaller change in the engine rotation speed N_{E} is the equal power shift, in which the automatic transmission 18 is shifted without changing the engine power P_{E} before and after the shift, and the shift with a larger change in the engine rotation speed N_{E} is the non-equal power shift, in which the automatic transmission 18 is shifted while the engine power P_{E} is changed before and after the shift, a proper engagement torque can be set at the time of each of the equal power shift and the non-equal power shift in the same type of shift in the automatic transmission 18.

According to this example, since the shift time inertia torque Tina is made larger when the a change amount of the engine power P_{E} before and after the shift is larger at the time of the non-equal power shift, a more proper shift can'be implemented in the same type of shift in the automatic transmission 18.

According to this example, since the equal power shift and the non-equal power shift are selected through a user operation, a proper engagement torque can be set in the same type of shift in the automatic transmission 18 when either the equal power shift or the non-equal power shift is selected through an operation by the user.

Although the example of the present invention has been described in detail with reference to the drawings, the present invention can be implemented in other forms.

For example, although the present invention is described by exemplarily illustrating an upshift in the example, the present invention is applicable to a downshift.

Although the automatic transmission 18 is a two-speed automatic transmission (decelerator) having the low-speed stage L and the high-speed stage H in the example, the present invention is applicable not only to the automatic transmission 18 but also to any mechanical shift mechanism disposed between the transmitting member 14 and the drive wheels 22 such that torque on the transmitting member 14 is transmitted to the drive wheels 22. For example, the automatic transmission 18 may be a planetary gear multistage transmission having three or more shift stages or a stepped automatic transmission allowing a transmission input torque to be increased at some or all the shift stages and transmitted toward the drive wheels 22.

Although the power distribution mechanism 16 is single-planetary in the example, the power distribution mechanism 16 may be double-planetary. The power distribution mechanism 16 may be, for example, a differential gear device having a pinion rotationally driven by the engine 12 and a pair of bevel gears meshing with the pinion operatively coupled to the first electric motor M1 and the transmitting member 14.

The above description is merely an embodiment and the present invention can be implemented in variously modified and improved forms based on the knowledge of those skilled in the art.

### Nomenclature of Elements

10: hybrid vehicle 12: engine 14: transmitting member (output rotating member) 16: power distribution mechanism (differential mechanism) 17: electric continuously variable transmission (electric shift mechanism) 18: automatic transmission (mechanical shift mechanism) 22: drive wheels 50: electronic control device (control device) B1, B2: first brake, second brake (engagement devices) MG1: first electric motor (differential electric motor) MG2: second electric motor (electric motor for running) RE1-RE3: first rotating element-third rotating element

1. A control device of a hybrid vehicle having an electric shift mechanism including a differential mechanism having three rotating elements, which are a first rotating element coupled to an engine in a power transmittable manner, a second rotating element coupled to a differential electric motor in a power transmittable manner, and a third rotating element that is an output rotating member coupled to an electric motor for running in a power transmittable manner, the electric shift mechanism having a differential state of the differential mechanism controlled by controlling an operational state of the differential electric motor, and a mechanical shift mechanism making up a portion of a power transmission path between the output rotating member of the electric shift mechanism and drive wheels, the mechanical shift mechanism having a shift stage formed by engagement of engagement devices,
the control device being configured to make a differential torque smaller between an output torque of the engine and an engagement torque of the engagement devices involved in a shift of the mechanical shift mechanism on the same shaft in a case of a shift with a smaller rotation speed change in the engine as compared to a case of a shift with a larger rotation speed change in the engine in the same type of shift in the mechanical shift mechanism.

2. The control device of a hybrid vehicle of claim 1, wherein the differential torque is a value set in advance for each of the case of the shift with a smaller rotation speed change in the engine and the case of the shift with a larger rotation speed change in the engine.

3. The control device of a hybrid vehicle of claim 1 wherein
the shift with a smaller rotation speed change in the engine is an equal power shift, in which the mechanical shift mechanism is shifted without changing an output power of the engine before and after the shift, and wherein
the shift with a larger rotation speed change in the engine is a non-equal power shift, in which the mechanical shift mechanism is shifted while an output power of the engine is changed before and after the shift.

4. The control device of a hybrid vehicle of claim 3, wherein in the case of the non-equal power shift, when a change amount of the output power of the engine before and after the shift is larger, the differential torque is made larger.

5. The control device of a hybrid vehicle of claim 3, wherein the equal power shift and the non-equal power shift are selected through a user operation.
